(19) United States
(12) Patent Application Publication
(10) Pub. No.: US 2025/0212082 A1
(43) Pub. Date: Jun. 26, 2025

(54) METHOD AND APPARATUS FOR MOBILITY ROBUSTNESS OPTIMIZATION

(71) Applicant: LENOVO (BEIJING) LIMITED, Beijing (CN)

(72) Inventors: Lianhai Wu, Beijing (CN); Le Yan, Shanghai (CN); Mingzeng Dai, Shanghai (CN); Xiaoying Xu, Shanghai (CN); Yibin Zhuo, Shanghai (CN)

(21) Appl. No.: 18/875,602

(22) PCT Filed: Jun. 17, 2022
(86) PCT No.: PCT/CN2022/099428

§ 371 Date: Dec. 16, 2024

(51) Int. Cl. H04W 36/30; H04W 8/18; H04W 24/10; H04W 36/14; H04W 36/36

(52) U.S. Cl. CPC H04W 36/305; H04W 8/186; H04W 24/10; H04W 36/142; H04W 36/362

(57) ABSTRACT

The present disclosure relates to methods and apparatuses for MRO in a communication system. According to some embodiments of the disclosure, a UE may: receive a UE information request message; and transmit a UE information response message in response to receiving the UE information request message. The UE information response message may include at least one of the following: a radio link failure (RLF) report associated with a multiple universal subscriber identity module (MUSIM) operation of the UE; or a successful handover report, wherein the handover may include a handover of the UE from a first radio access technology (RAT) to a second RAT for voice fallback.

### TECHNICAL FIELD

The present disclosure generally relates to communication technology, and more particularly to mobility robustness optimization (MRO) in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

A wireless communication system may include at least one base station or network access node supporting communication for a communication device(s), which may otherwise be referred to as user equipment (UE).

There is a need for efficiently performing communication in a communication system.

### SUMMARY

Some embodiments of the present disclosure provide a user equipment (UE). The UE may include: a transceiver; and a processor coupled to the transceiver, wherein the processor may be configured to: receive a UE information request message; and transmit a UE information response message in response to receiving the UE information request message, wherein the UE information response message may include at least one of the following: a radio link failure (RLF) report associated with a multiple universal subscriber identity module (MUSIM) operation of the UE; or a successful handover report, wherein the handover may include a handover of the UE from a first radio access technology (RAT) to a second RAT for voice fallback.

Some embodiments of the present disclosure provide a base station (BS). The BS may include: a transceiver; and a processor coupled to the transceiver. The processor may be configured to: transmit, to a user equipment (UE), a UE information request message; and receive, from the UE, a UE information response message in response to transmitting the UE information request message, wherein the UE information response message may include at least one of the following: a radio link failure (RLF) report associated with a multiple universal subscriber identity module (MUSIM) operation of the UE; or a successful handover report, wherein the handover may include a handover of the UE from a first radio access technology (RAT) to a second RAT for voice fallback.

Some embodiments of the present disclosure provide a method for wireless communication performed by a user equipment (UE). The method may include: receiving a UE information request message; and transmitting a UE information response message in response to receiving the UE information request message, wherein the UE information response message may include at least one of the following: a radio link failure (RLF) report associated with a multiple universal subscriber identity module (MUSIM) operation of the UE; or a successful handover report, wherein the handover may include a handover of the UE from a first radio access technology (RAT) to a second RAT for voice fallback.

In some embodiments of the present disclosure, the UE may include a first USIM and the UE is in a connected state in a first radio access network (RAN) associated with the first USIM. The method may further include: prohibiting initiating a reestablishment procedure in response to detecting an RLF associated with the first RAN when a timer for leaving without a response is running; prohibiting storing RLF information in response to detecting the RLF associated with the first RAN when the timer for leaving without a response is running; storing the RLF information in response to detecting the RLF associated with the first RAN when the timer for leaving without a response is not running; or storing the RLF information in response to detecting the RLF associated with the first RAN when the timer for leaving without a response is running.

In some embodiments of the present disclosure, the RLF report associated with the MUSIM operation may include the RLF information or both the RLF information and an indication. The indication indicates that the timer for leaving without a response is running when the RLF is detected.

In some embodiments of the present disclosure, the UE may include a first USIM and the UE is in a connected state in a first radio access network (RAN) associated with the first USIM. The method may further include: transmitting, to the first RAN, a UE assistant information message to request to leave the connected state in the first RAN; and starting a timer for leaving without a response in response to the transmission of the UE assistant information message.

In some embodiments of the present disclosure, the method may further include at least one of: prohibiting executing a conditional handover (CHO) in response to a CHO execution condition being met when the timer for leaving without a response is running; stopping evaluating a CHO execution condition when the timer for leaving without a response is running; or prohibiting performing a handover (HO) command received from the first RAN when the timer for leaving without a response is running.

In some embodiments of the present disclosure, the method may further include re-entering the connected state in the first RAN. The UE information request message is received after re-entering the connected state in the first RAN. The RLF report associated with the MUSIM operation may include at least one of the following: a first indication indicating that a CHO is not performed or indicating that a CHO is not performed when the timer for leaving without a response is running; a second indication indicating that CHO evaluation is stopped when the timer for leaving without a response is running; or a third indication indicating that a HO command is not performed or indicating that a HO command is received when the timer for leaving without a response is running.

In some embodiments of the present disclosure, the method may further include: receiving a command for the handover from the first RAT to the second RAT, wherein the command is for voice fallback; and successfully accessing a cell associated with the second RAT according to the command.

In some embodiments of the present disclosure, the method may further include storing information associated with the handover from the first RAT to the second RAT in response to a trigger condition for reporting a successful handover report being met. The UE information request message is received after successfully accessing the cell associated with the second RAT. The successful handover report may include at least one of the following: a voice fallback indication; or information related to the cell associated with the second RAT.

In some embodiments of the present disclosure, the information related to the cell associated with the second RAT may include at least one of the following: a first indication indicating that a physical layer problem timer is started within a period after the handover from the first RAT to the second RAT; or a second indication indicating that a timer associated with measurement report triggering is started within a period after the handover from the first RAT to the second RAT.

In some embodiments of the present disclosure, the method may further include prohibiting storing information associated with the handover from the first RAT to the second RAT in response to a trigger condition for reporting a successful handover report being met.

Some embodiments of the present disclosure provide a method for wireless communication performed by a base station (BS). The method may include: transmitting, to a user equipment (UE), a UE information request message; and receiving, from the UE, a UE information response message in response to transmitting the UE information request message, wherein the UE information response message may include at least one of the following: a radio link failure (RLF) report associated with a multiple universal subscriber identity module (MUSIM) operation of the UE; or a successful handover report, wherein the handover may include a handover of the UE from a first radio access technology (RAT) to a second RAT for voice fallback.

In some embodiments of the present disclosure, the first BS is associated with a first radio access network (RAN). The RLF report associated with the MUSIM operation may include information of an RLF between a second BS associated with the first RAN and the UE, and an indication which indicates that a timer for leaving without a response is running at the UE when the RLF occurs.

In some embodiments of the present disclosure, the first BS is associated with a first radio access network (RAN). The RLF report associated with the MUSIM operation may include at least one of the following: a first indication indicating that a conditional handover (CHO) is not performed at the UE or indicating that a CHO is not performed at the UE when a timer for leaving without a response is running at the UE; a second indication indicating that CHO evaluation is stopped at the UE when the timer for leaving without a response is running at the UE; or a third indication indicating that a handover (HO) command is not performed at the UE or indicating that a HO command is received at the UE when the timer for leaving without a response is running at the UE, wherein the HO command is transmitted from a second BS associated with the first RAN.

In some embodiments of the present disclosure, the first BS is associated with the second RAT. The successful handover report may include at least one of the following: a voice fallback indication; or information related to a serving cell of the UE.

In some embodiments of the present disclosure, the information related to the serving cell of the UE may include at least one of the following: a first indication indicating that a physical layer problem timer is started within a period after a successful handover of the UE from the first RAT to the serving cell of the UE; or a second indication indicating that a timer associated with measurement report triggering is started within a period after the successful handover of the UE from the first RAT to the serving cell of the UE.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flow chart of an exemplary UE assistance information procedure in accordance with some embodiments of the present disclosure;

FIG. 3 illustrates a flow chart of an exemplary inter-radio access technology (RAT) handover procedure in accordance with some embodiments of the present disclosure;

FIG. 4 illustrates a flow chart of an exemplary UE information procedure in accordance with some embodiments of the present disclosure;

FIGS. 5-10 illustrate flow charts of exemplary procedures of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments may be provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

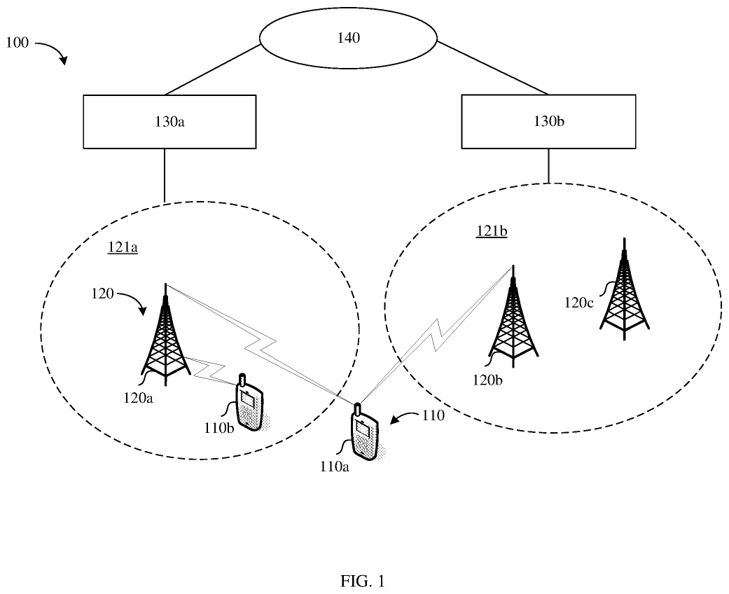

FIG. 1 illustrates a schematic diagram of wireless communication system 100 in accordance with some embodiments of the present disclosure.

Referring to FIG. 1, wireless communication system 100 may include some UEs (e.g., UE 110a and UE 110b), some BSs 120 (e.g., BS 120a, BS 120b, and BS 120c), some RANs (e.g., RAN 121a and RAN 121b), some core networks (e.g., CN 130a and CN 130b), and a public switched telephone network (e.g., PSTN 140). It is contemplated that the wireless communication system 100 may include any number of UEs, BSs, networks, and/or network components.

The UEs and the BSs may support communication based on, for example, 3G, long-term evolution (LTE), LTE-advanced (LTE-A), new radio (NR), or other suitable protocol(s). In some embodiments of the present disclosure, BS 120 may also be referred to as an access point, an access terminal, a base, a base unit, a macro cell, a Node-B, an evolved Node B (eNB), a gNB, an ng-eNB, a Home Node-B, a relay node, or a device, or described using other terminology used in the art. BS 120 may be any type of device configured to wirelessly interface with at least one UE (e.g., UE 110) to facilitate access to one or more communication networks, such as CN 130a and CN 130b.

BS 120 is generally a part of a RAN that may include one or more controllers communicably coupled to one or more corresponding BSs. In the context of the present disclosure, “configured by a RAN can be interpreted” as configured by a BS associated with the RAN, or vice versa. For example, referring to FIG. 1, BS 120a may be part of RAN 121a, which may also include other BSs and/or network elements (not shown), such as a base station controller (BSC), a radio network controller (RNC), relay nodes, etc. BS 120b and BS 120c may be a part of RAN 121b that in addition to, may also include other BSs and/or network elements (not shown in FIG. 1). Each of the BS 120a, BS 120b, and BS 120c may be configured to transmit and/or receive wireless signals within a particular geographic region, which may be referred to as a cell (not shown in FIG. 1).

RAN 121a may be in communication with CN 130a, and RAN 121b may be in communication with CN 130b. RAN 121a and RAN 121b may employ the same or different radio access technologies (RATs). For example, RAN 121a may employ an evolved universal terrestrial radio access network (E-UTRAN) radio technology, and RAN 121b may employ NR technology. For example, both RAN 121a and RAN 121b may employ the NR technology. Each of CN 130a and CN 130b may include a plurality of core network components, such as a mobility management entity (MME) (not shown in FIG. 1) or an access and mobility management function (AMF) (not shown in FIG. 1). The CNs may serve as gateways for the UEs to access PTSN 140 and/or other networks (not shown in FIG. 1).

UE 110 may be any type of device configured to operate and/or communicate in a communication system (e.g., a wireless environment). UE 110 may include may include, for example, but is not limited to, a computing device, a wearable device, a portable device, a mobile device, an IoT device, a vehicle, etc. Persons skilled in the art should understand that as technology develops and advances, the terminologies described in the present disclosure may change, but should not affect or limit the principles and spirit of the present disclosure. UE 110 may communicate with BS 120 via uplink (UL) communication signals. BS 102 may communicate with UE 110 via downlink (DL) communication signals.

In some embodiments, UE 110 may include one or more subscriber identity modules (SIMs) that enable it to access one or more separate wireless communication networks. For example, UE 110b may include a single SIM (not shown in FIG. 1) and may be configured to access RAN 121a through BS 120a by virtue of the single SIM. UE 110a may be configured to access either RAN 121a through BS 120a by virtue of SIM #1 (not shown in FIG. 1) in UE 110a or RAN 121b through BS 120b by virtue of SIM #2 (not shown in FIG. 1) in UE 110a. While UE 110a is shown accessing RAN 121a and RAN 121b, in other examples (not shown), the UE 110a may establish additional network connections using additional RATs.

Each of SIM #1 and SIM #2 may be associated with a kind of wireless communication system. For example, either SIM #1 and SIM #2 may be represented by a SIM card corresponding to a GSM system, a universal subscriber identity module (USIM) card corresponding to a UMTS system, a removable user identity module (RUIM) card or a CDMA subscriber identity module (CSIM) card corresponding to the CDMA2000 communication system, a universal integrated circuit card (UICC) corresponding to a 5G (NR) communication system, a wireless network card corresponding to an IEEE 802.11x wireless local area network (WLAN), or other suitable modules that can identify subscribers.

A multi-SIM UE may be implemented as a multi-SIM-single-standby (MSSS) UE, a multi-SIM-multi-standby (MSMS) UE, a multi-SIM-multi-active (MSMA) UE, etc.

For example, a UE that includes a plurality of SIMs and connects to two or more networks with two or more SIMs being active at a given time may be referred to as an MSMA UE. An example MSMA UE may be a dual-SIM-dual-active (DSDA) UE, which may include two SIMs. Both SIMs of a DSDA UE may remain active. For example, a UE provided with a plurality of SIMs and connected to two or more networks with one SIM being active at a given time may be referred to as an MSMS UE. An example of the MSMS UE may be a dual-SIM-dual-standby (DSDS) UE. A DSDS UE may include two SIMs, and may use a single radio front-end and baseband to register the communication device to a single (the same) public land mobile network or to two different PLMNs with the two SIMs, respectively.

In a multi-SIM UE, the plurality of SIMs may share a common set of radio frequency (RF) resources (such as a RF transceiver) of the UE. However, embodiments described herein may also be applicable to a multi-SIM UE in which each of the plurality of SIMs is associated with a separate RF resource.

In some embodiments of the present disclosure, a multi-SIM UE in a connected state (e.g., RRC_CONNECTED state as specified in 3GPP specifications) in network A may switch from network A to network B. For example, network A may be an NR system and network B may be an E-UTRA system or an NR system. For instance, referring to FIG. 1, UE 110a may be in a connected state in RAN 121a and may switch from RAN 121a to RAN 121b to, for example, receive a service in RAN 121b. Before switching from network A to network B, a multi-SIM UE should notify network A that the UE is to leave the connected state in network A, for example, switch to an inactive or idle state (e.g., RRC_INACTIVE state or RRC_IDLE state as specified in 3GPP specifications), or that the UE is to be kept in the connected state in network A. Such notification can be transmitted via a UE assistance information message, which will be described in detail below.

In some embodiments of the present disclosure, a multi-SIM UE can signal network A the preference to leave a connected state by radio resource control (RRC) signaling or non-access stratum (NAS) signaling when the UE is configured to do so. After the UE transmits the preference to leave the connected state by, for example, RRC signaling, in the case that the UE does not receive an RRC release message from network A within a certain time period (if configured by network A), the UE can autonomously enter an idle state in network A. The certain time period may be configured by an RRC reconfiguration message (e.g., indicated by a MUSIM-LeaveWithoutResponseTimer information element (IE)).

In some embodiments of the present disclosure, a multi-SIM UE can signal network A the preference to be kept in the connected state in network A while temporarily switching to network B, which can be indicated by scheduling a gap preference. The gap preference can include information for the setup or release of gaps.

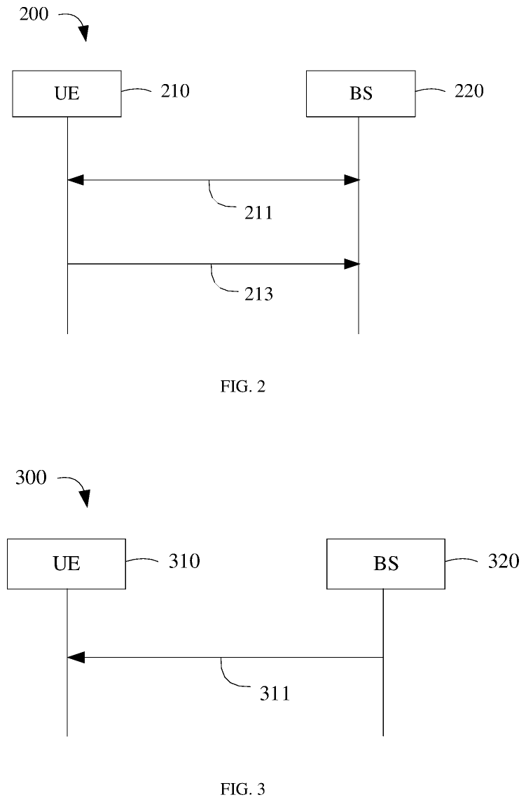

FIG. 2 illustrates a flow chart of an exemplary UE assistance information procedure 200 in accordance with some embodiments of the present disclosure. Details described in all of the foregoing embodiments of the present disclosure are applicable for the embodiments shown in FIG. 2.

Referring to FIG. 2, UE 210 and BS 220 may function as UE 110 and BS 120 shown in FIG. 1, respectively. In operation 211, UE 210 and BS 220 may interact to perform an RRC reconfiguration operation. For example, BS 220 may transmit an RRC reconfiguration message to UE 210. The RRC reconfiguration message may indicate UE 210 to report assistant information to BS 220. Under certain scenarios, UE 210 may, in operation 213, transmit a UE assistance information message to BS 220.

For example, UE 210 may use the UE assistance information message to inform the network of the following information:
its preference on the minimum scheduling offset for cross-slot scheduling for power saving;
its preference on the RRC state;
its preference in being provisioned with reference time information;
its multi-SIM (e.g., multiple USIM (MUSIM)) assistance information; or
any combination thereof.

In some embodiments of the present disclosure, a UE may initiate the UE assistance information procedure (e.g., if the UE is configured to do so). For example, a UE capable of providing multi-SIM assistance information may initiate the above procedure (e.g., if the UE is configured to do so) in response to determining to leave a connected state or that it needs a gap(s), or in response to, for example, a change of the gap information without leaving the connected state.

It should be appreciated by persons skilled in the art that the sequence of the operations in exemplary procedure 200 may be changed and some of the operations in exemplary procedure 200 may be eliminated or modified, without departing from the spirit and scope of the disclosure.

In some embodiments of the present disclosure, a UE may be configured with a conditional handover (CHO) configuration via, for example, an RRC reconfiguration message. The CHO configuration may be associated with at least one execution condition for at least one candidate node. The candidate node for the CHO may be either a relay node or a cell. Each candidate node of the at least one candidate node may be associated with one or more execution conditions. The execution condition may be generated by a source BS of the UE. The CHO configuration may include a configuration of the candidate node generated by the candidate BS (e.g., a BS of the candidate cell or a BS serving the candidate relay node).

In some embodiments of the present disclosure, the UE may start evaluating the at least one execution condition in response to receiving the CHO configuration. In response to an execution condition for a candidate node being met, the UE may select the candidate node as a target node and may initiate a CHO procedure with the target node. The UE may stop evaluating the execution condition during the CHO execution or initiation of the CHO procedure.

In some embodiments of the present disclosure, an inter-RAT handover, which may refer to a handover from a RAT (source RAT, such as 5G or LTE) to another RAT (target RAT, such as LTE or 5G), may occur. The inter-RAT handover may be characterized by one or more of the following:
The source RAT configures the target RAT measurement and reporting.
The source RAT decides on the preparation initiation and provides the necessary information to the target RAT in the format required by the target RAT.
Radio resources are prepared in the target RAT before the handover.
An RRC reconfiguration message from the target RAT may be delivered to the source RAT via a transparent container, and may be passed to the UE to be handed-over by the source RAT in a handover command.

The purpose of the inter-RAT handover may include moving a UE in a connected state (e.g., RRC_CONNECTED state as specified in 3GPP specifications) to a cell using another RAT. When such procedure moves a UE from 5G to another RAT such as E-UTRA or UTRA-FDD, the procedure may be referred to as mobility from NR procedure.

In some embodiments of the present disclosure, a network (e.g., a BS) may initiate an inter-RAT handover procedure (e.g., mobility from NR procedure) to a UE in a connected state in response to, for example, a measurement report message (e.g., MeasurementReport as specified in 3GPP specifications) or a failure information message (e.g., MCGFailureInformation message as specified in 3GPP specifications). For example, the network may transmit a handover command (e.g., MobilityFromNRCommand as specified in 3GPP specifications) to the UE, which may include the radio resources that have been allocated for the UE in the target cell. For example, the handover command may include the RRC reconfiguration message from the target RAT. In some embodiments of the present disclosure, a voice fallback indication may be included in the handover command, and thus the UE may attempt to select, for example, an E-UTRA cell, in the case that the handover fails.

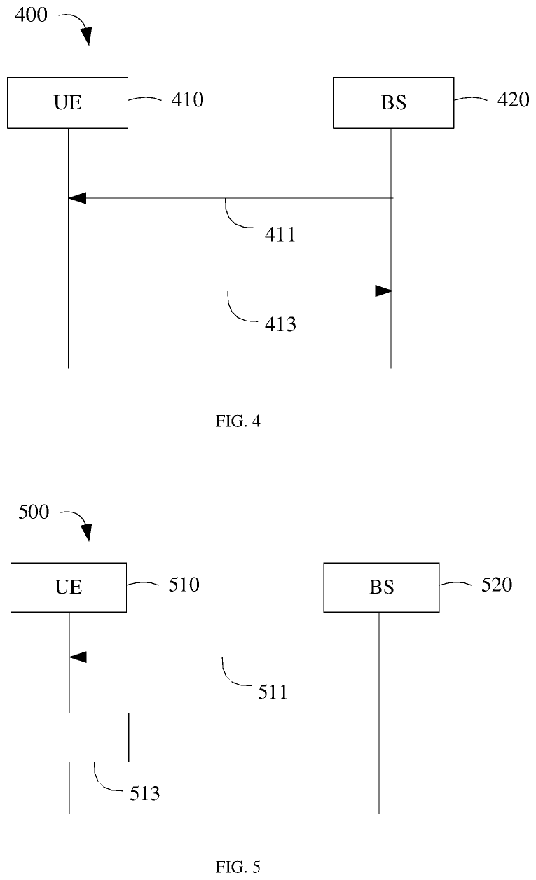

FIG. 3 illustrates a flow chart of exemplary inter-RAT handover procedure 300 in accordance with some embodiments of the present disclosure. Details described in all of the foregoing embodiments of the present disclosure are applicable for the embodiments shown in FIG. 3.

Referring to FIG. 3, UE 310 and BS 320 may function as UE 110 and BS 120 shown in FIG. 1, respectively. UE 310 may access BS 320 and may transmit a measurement report to BS 320.

In operation 311, BS 320 may transmit a handover command (e.g., an RRC reconfiguration message including a reconfiguration with synchronization) to UE 310. The handover command may indicate an inter-RAT handover of the UE 310 from a RAT (e.g., 5G) to another RAT (e.g., LTE), which may be associated with a target cell (not shown in FIG. 3). In response to receiving the handover command, UE 310 may initiate a random access procedure with the target cell.

It should be appreciated by persons skilled in the art that the sequence of the operations in exemplary procedure 300 may be changed and some of the operations in exemplary procedure 300 may be eliminated or modified, without departing from the spirit and scope of the disclosure.

In some embodiments of the present disclosure, a UE information procedure may occur. The procedure may be used by a network to request a UE to report information. The network may initiate this procedure only after a successful security activation.

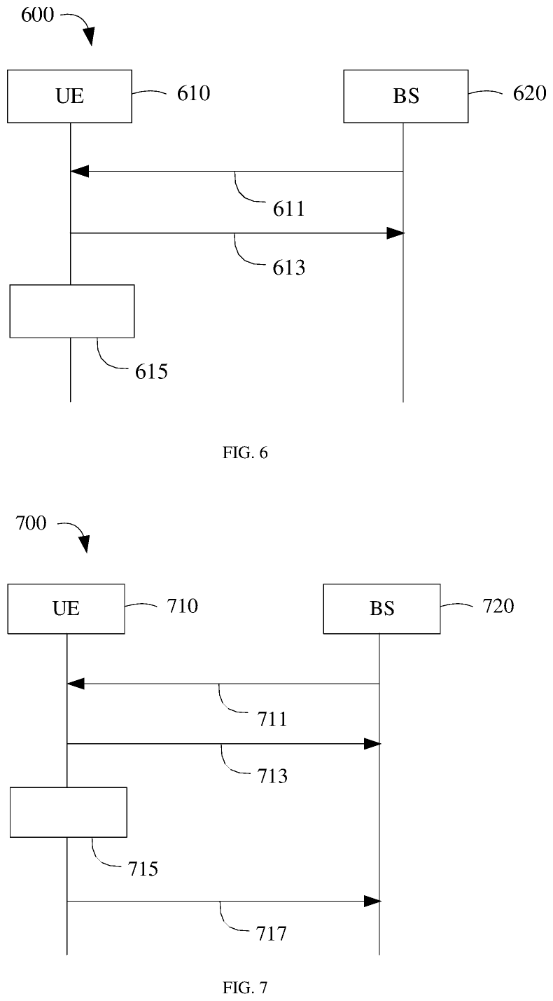

FIG. 4 illustrates a flow chart of exemplary UE information procedure 400 in accordance with some embodiments of the present disclosure. Details described in all of the foregoing embodiments of the present disclosure are applicable for the embodiments shown in FIG. 4.

Referring to FIG. 4, UE 410 and BS 420 may function as UE 110 and BS 120 shown in FIG. 1, respectively. In operation 411, BS 420 may transmit a UE information request message to UE 410. In operation 413, UE 410 may transmit a UE information response message in response to the UE information request message.

In some embodiments, the UE information response message may include a radio link failure (RLF) report. For example, the UE information request message may indicate that the UE should report information about an RLF. The UE information response message may include RLF information or handover failure information.

It should be appreciated by persons skilled in the art that the sequence of the operations in exemplary procedure 400 may be changed and some of the operations in exemplary procedure 400 may be eliminated or modified, without departing from the spirit and scope of the disclosure.

Providing the RLF report to the network can facilitate the mobility robustness optimization (MRO) in a communication network (e.g., NR networks). In some embodiments, the MRO function in a communication network can be further enhanced to provide more robust mobility by reporting failure events observed during successful handovers. To achieve this goal, a UE may be configured to compile a report associated with a successful handover including, for example, a set of measurements collected during the handover phase including, for example, a measurement at the handover trigger, a measurement at the end of the handover execution, or a measurement after the handover execution. In some embodiments, the UE may be configured with one or more triggering conditions to compile the successful handover report, and the report would only be triggered only if the condition(s) is met. This limits UE reporting to relevant cases, such as underlying issues detected by radio link monitoring (RLM), or beam failure detection (BFD) detected in response to a successful handover event.

The availability of a successful handover report may be indicated by the handover complete message (e.g., an RRC reconfiguration complete message) transmitted from the UE to the target BS (e.g., a next-generation radio access network NG-RAN node). The target BS may fetch information of a successful handover report via the UE information procedure as described above. For example, referring to FIG. 4, the UE information request message may indicate that the UE should report information about a successful handover. The UE information response message may include a successful handover report. In some embodiments, the target BS may forward the successful handover report to the source BS (e.g., a NR-RAN node) to indicate a failure(s) experienced during a successful handover event.

In response to the reception of the successful handover report, the receiving node (e.g., the target BS or the source BS) is able to analyze whether its mobility configuration needs adjustment. Such adjustment may result in changes of mobility configurations, such as changes of RLM configurations or changes of mobility thresholds between the source and the target. In some embodiments, the target BS, in the performed handover, may further optimize the dedicated random access channel (RACH)-beam resources based on the beam measurements reported in response to the successful handover(s).

Embodiments of the present disclosure propose technical solutions for facilitating the MRO in a communication network. For example, an enhanced MRO is provided in the case of a multi-SIM. For instance, the impact of a multi-SIM related timer on the RLF report is considered. For example, an enhanced MRO is provided in the case of an inter-system (e.g., inter-RAT) handover for voice fallback. Distinguishing a normal handover and a voice fallback handover may be beneficial since it is of a high probability that a voice fallback handover may have a relative long random access and using a sample for the voice fallback handover to optimize the normal handover may be inappropriate. More details on the embodiments of the present disclosure will be illustrated in the following text in combination with the appended drawings.

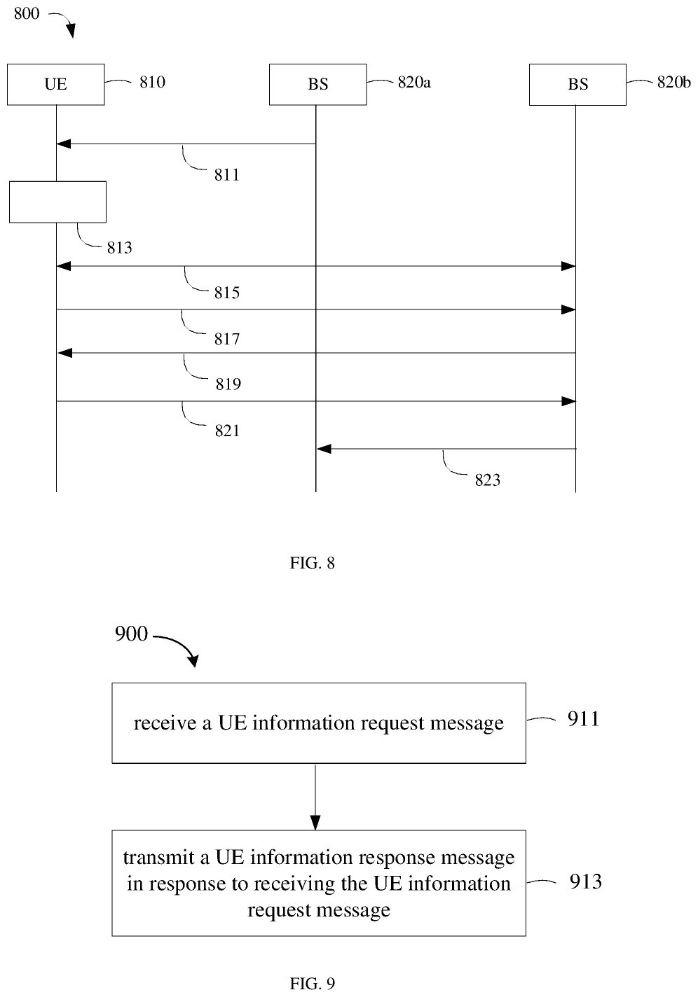

FIG. 5 illustrates a flow chart of exemplary procedure 500 of wireless communications in accordance with some embodiments of the present disclosure. Details described in all of the foregoing embodiments of the present disclosure are applicable for the embodiments shown in FIG. 5.

Referring to FIG. 5, UE 510 and BS 520 may function as UE 110 and BS 120 shown in FIG. 1, respectively. UE 510 may include USIM #5A and USIM #5B. UE 510 may access a network (denoted as “network #5A”) via BS 520 and may be in a connected state in network #5A. UE 510 may be in an idle or inactive state in another network (denoted as “network #5B”). Network #5A and network #5B may be associated with USIM #5A and USIM #5B, respectively. For example, UE 510 may access network #5A via USIM #5A, and access network #5B via USIM #5B.

In operation 511, UE 510 may receive a configuration message (e.g., an RRC reconfiguration message) from BS 520 (or network #5A). In some embodiments of the present disclosure, the configuration message may indicate a UE to report assistance information, such as MUSIM related assistance information. The assistance information described above may apply here.

For example, in some embodiments, the configuration message may indicate the UE to report assistance information related to “without leaving the connected state for MUSIM purposes”. For example, the configuration message may include a MUSIM-GapAssistanceConfig information element (IE).

For example, in some embodiments, the configuration message may indicate the UE to report assistance information related to “leaving the connected state for MUSIM purposes”. For example, the configuration message may include a musim-LeaveAssistanceConfig IE.

In some embodiments, a timer for leaving without a response (e.g., T346g as specified in 3GPP specifications) may be configured. UE 510 may start the timer in response to the transmission of a UE assistant information message indicating that UE 510 is to leave a connected state in network #5A. When the timer expires, UE 510 can autonomously leave the connected state and enter an idle state in network #5A for the purpose of MUSIM operations. For example, the musim-LeaveAssistanceConfig 1E may include a musim-LeaveWithoutResponseTimer IE, which indicates the timer (e.g., a value of the timer).

In some embodiments of the present disclosure, the configuration message may indicate a CHO configuration for UE 510. In some embodiments of the present disclosure, the configuration message may not indicate a CHO configuration for UE 510.

In operation 513, UE 510 may detect an RLF associated with network #5A (e.g., an RLF on the link between UE 510 and BS 520). In some embodiments, the RLF may be detected when the timer for leaving without a response is not running. In this scenario, UE 510 may store related RLF information. For example, the RLF information may be stored in a variable for RLF report (e.g., VarRLF-Report as specified in 3GPP specifications).

In response to the RLF, UE 510 may perform a reestablishment procedure. During the reestablishment procedure, UE 510 may select a cell. The selected cell is associated with network #5A. UE 510 may report the RLF information to the selected cell. For example, UE 510 may report the RLF information to the selected cell via, for example, a UE information procedure. The UE information procedure as described above may apply here. For instance, UE 510 may receive a UE information request message from network #5A (e.g., the selected cell), and may transmit a UE information response message in response to the received UE information request message. The UE information response message may include the RLF information (e.g., an RLF report).

In some other embodiments, the RLF may be detected when the timer for leaving without a response is running. For example, UE 510 may transmit a UE assistance information message to BS 520 to indicate that UE 510 has determined to leave the connected state in network #5A (not shown in FIG. 5). UE 510 may start the timer for leaving without a response in response to the transmission of the UE assistant information message. The RLF may be detected when the timer for leaving without a response is running. In this scenario, UE 510 may not store the RLF information. In addition, UE 510 may not initiate a reestablishment procedure in response to the RLF.

It should be appreciated by persons skilled in the art that the sequence of the operations in exemplary procedure 500 may be changed and some of the operations in exemplary procedure 500 may be eliminated or modified, without departing from the spirit and scope of the disclosure.

FIG. 6 illustrates a flow chart of exemplary procedure 600 of wireless communications in accordance with some embodiments of the present disclosure. Details described in all of the foregoing embodiments of the present disclosure are applicable for the embodiments shown in FIG. 6.

Referring to FIG. 6, UE 610 and BS 620 may function as UE 110 and BS 120 shown in FIG. 1, respectively. UE 610 may include USIM #6A and USIM #6B. UE 610 may access a network (denoted as “network #6A”) via BS 620 and may be in a connected state in network #6A. UE 610 may be in an idle or inactive state in another network (denoted as “network #6B”). Network #6A and network #6B may be associated with USIM #6A and USIM #6B, respectively. For example, UE 610 may access network #6A via USIM #6A, and access network #6B via USIM #6B.

In operation 611, UE 610 may receive a configuration message (e.g., an RRC reconfiguration message) from BS 620 (or network #6A). In some embodiments of the present disclosure, the configuration message may indicate a UE to report assistance information, such as MUSIM related assistance information. The assistance information described above may apply here.

For example, in some embodiments, the configuration message may indicate the UE to report assistance information related to “without leaving the connected state for MUSIM purposes”. For example, the configuration message may include a MUSIM-GapAssistanceConfig information element (IE).

For example, in some embodiments, the configuration message may indicate the UE to report assistance information related to “leaving the connected state for MUSIM purposes”. For example, the configuration message may include a musim-LeaveAssistanceConfig IE.

In some embodiments, a timer for leaving without a response (e.g., T346g as specified in 3GPP specifications) may be configured. UE 610 may start the timer in response to the transmission of a UE assistant information message indicating that UE 610 is to leave a connected state in network #6A. When the timer expires, UE 610 can autonomously leave the connected state and enter an idle state in network #6A for the purpose of MUSIM operations. For example, the musim-LeaveAssistanceConfig 1E may include a musim-Leave WithoutResponseTimer IE, which indicates the timer (e.g., a value of the timer).

In some embodiments of the present disclosure, the configuration message may indicate a CHO configuration for UE 610. In some embodiments of the present disclosure, the configuration message may not indicate a CHO configuration for UE 610.

In some embodiments of the present disclosure, UE 610 may determine to leave the connected state in network #6A (e.g., preferred state as an idle state). UE 610 may make such determination for the purpose of MUSIM operations, for example, when it receives a paging message from network #6B, wants to transmit a busy indication to network #6B, or wants to receive system information from network #6B.

In operation 613, UE 610 may transmit a UE assistance information message to BS 620. The UE assistance information message may indicate an idle state or inactive state as the preferred state (e.g., UE 610 has determined to leave the connected state in network #6A). In response to the transmission of the UE assistant information message, UE 610 may start the timer for leaving without a response.

In operation 615, UE 610 may detect an RLF associated with network #6A (e.g., an RLF on the link between UE 610 and BS 620). The RLF may be detected when the timer for leaving without a response is running. In this scenario, although UE 610 is required to detect the RLF, UE 610 may not be required to initiate a reestablishment procedure in response to the detection of RLF. In other words, UE 610 may prohibit the initiation of a reestablishment procedure in response to detecting an RLF associated with network #6A when the timer for leaving without a response is running. UE 610 may store the RLF information in response to detecting the RLF when the timer for leaving without a response is running. For example, the RLF information may be stored in a variable for RLF report (e.g., VarRLF-Report as specified in 3GPP specifications).

In response to the expiry of the timer for leaving without a response, UE 610 may autonomously leave the connected state and enter an idle state in network #6A.

In some embodiments, UE 610 may (re) enter a connected state in network #6A. For example, UE 610 may access BS 620 or another BS (not shown in FIG. 6) associated with network #6A. UE 610 may report the RLF information to network #6A via, for example, a UE information procedure. The UE information procedure as described above may apply here. For instance, UE 610 may receive a UE information request message from network #6A, and may transmit a UE information response message in response to the received UE information request message. The UE information response message may include the stored RLF information (e.g., an RLF report). In some embodiments, an indication which indicates that the timer for leaving without a response is running or that the timer for leaving without a response is running when the RLF is detected may also be added to the RLF report. In some other embodiments, such indication may be stored along with the RLF information.

It should be appreciated by persons skilled in the art that the sequence of the operations in exemplary procedure 600 may be changed and some of the operations in exemplary procedure 600 may be eliminated or modified, without departing from the spirit and scope of the disclosure.

FIG. 7 illustrates a flow chart of exemplary procedure 700 of wireless communications in accordance with some embodiments of the present disclosure. Details described in all of the foregoing embodiments of the present disclosure are applicable for the embodiments shown in FIG. 7.

Referring to FIG. 7, UE 710 and BS 720 may function as UE 110 and BS 120 shown in FIG. 1, respectively. UE 710 may include USIM #7A and USIM #7B. UE 710 may access a network (denoted as “network #7A”) via BS 720 and may be in a connected state in network #7A. UE 710 may be in an idle or inactive state in another network (denoted as “network #7B”). Network #7A and network #7B may be associated with USIM #7A and USIM #7B, respectively. For example, UE 710 may access network #7A via USIM #7A, and access network #7B via USIM #7B.

In operation 711, UE 710 may receive a configuration message (e.g., an RRC reconfiguration message) from BS 720 (or network #7A). In some embodiments of the present disclosure, the configuration message may indicate a UE to report assistance information, such as MUSIM related assistance information. The assistance information described above may apply here.

For example, in some embodiments, the configuration message may indicate the UE to report assistance information related to “without leaving the connected state for MUSIM purposes”. For example, the configuration message may include a MUSIM-GapAssistanceConfig information element (IE).

For example, in some embodiments, the configuration message may indicate the UE to report assistance information related to “leaving the connected state for MUSIM purposes”. For example, the configuration message may include a musim-LeaveAssistanceConfig IE.

In some embodiments, a timer for leaving without a response (e.g., T347g as specified in 3GPP specifications) may be configured. UE 710 may start the timer in response to the transmission of a UE assistant information message indicating that UE 710 is to leave a connected state in network #7A. When the timer expires, UE 710 can autonomously leave the connected state and enter an idle state in network #7A for the purpose of MUSIM operations. For example, the musim-LeaveAssistanceConfig 1E may include a musim-LeaveWithoutResponseTimer IE, which indicates the timer (e.g., a value of the timer).

In some embodiments of the present disclosure, the configuration message may indicate a CHO configuration for UE 710. In some embodiments of the present disclosure, the configuration message may not indicate a CHO configuration for UE 710.

In some embodiments of the present disclosure, UE 710 may determine to leave the connected state in network #7A. UE 710 may make such determination for the purpose of MUSIM operations, for example, when it receives a paging message from network #7B, wants to transmit a busy indication to network #7B, or wants to receive system information from network #7B.

In operation 713, UE 710 may transmit a UE assistance information message to BS 720. The UE assistance information message may indicate an idle state or inactive state as the preferred state (e.g., UE 710 has determined to leave the connected state in network #7A). In response to the transmission of the UE assistant information message, UE 710 may start the timer for leaving without a response.

In some embodiments of the present disclosure, UE 710 may be configured with a CHO configuration by network #7A (e.g., BS 720). In operation 715, UE 710 may determine that a CHO execution condition is met when the timer for leaving without a response is running. In this scenario, UE 710 may not execute the CHO. In other words, UE 710 may prohibit executing a CHO in response to a CHO execution condition being met when the timer for leaving without a response is running. As will be described later, a corresponding indication may be reported to network #7A in operation 717 to indicate this situation.

In some embodiments of the present disclosure, UE 710 may stop evaluating the CHO execution condition when the timer for leaving without a response is running. For example, when the CHO configuration is configured, UE 710 may stop evaluating the configured CHO execution condition in response to starting the timer for leaving without a response is running. As will be described later, a corresponding indication may be reported to network #7A in operation 717 to indicate this situation.

In some embodiments of the present disclosure, UE 710 may receive a handover (HO) command when the timer for leaving without a response is running. In this scenario, UE 710 may not perform the HO command. As will be described later, a corresponding indication may be reported to network #7A in operation 717 to indicate this situation.

In some embodiments of the present disclosure, in operation 715, UE 710 may detect an RLF associated with network #7A (e.g., an RLF on the link between UE 710 and BS 720). In some embodiments, the RLF may be detected when the timer for leaving without a response is running. In this scenario, although UE 710 is required to detect the RLF, UE 710 may not be required to initiate a reestablishment procedure in response to the RLF. In other words, UE 710 may prohibit the initiation of a reestablishment procedure in response to detecting an RLF associated with network #7A when the timer for leaving without a response is running.

In some embodiments of the present disclosure, as described above, UE 710 may store the RLF information in response to detecting the RLF when the timer for leaving without a response is running. For example, the RLF information may be stored in a variable for RLF report (e.g., VarRLF-Report as specified in 3GPP specifications). In some other embodiments of the present disclosure, as described above, UE 710 may not store the RLF information in response to detecting the RLF when the timer for leaving without a response is running.

In response to the expiry of the timer for leaving without a response, UE 710 may autonomously leave the connected state and enter an idle state in network #7A.

In some embodiments of the present disclosure, UE 710 may (re) enter a connected state in network #7A. For example, UE 710 may access BS 720 or another BS (not shown in FIG. 7) associated with network #7A. For simplicity, FIG. 7 assumes that UE 710 accesses BS 720.

In some embodiments, as described above, UE 710 may report the RLF information to network #7A via, for example, a UE information procedure after (re) entering the connected state in network #7A. For example, UE 710 may transmit a UE information response message to network #7A in operation 717.

In some embodiments, the UE information response message may include the RLF information (e.g., an RLF report) or both the RLF information and an indication which indicates that the timer for leaving without a response is running when the RLF is detected.

In some embodiments, the UE information response message may include an indication which indicates that a CHO is not performed. To put this another way, the indication may indicate that a CHO is not performed when the timer for leaving without a response is running.

In some embodiments, the UE information response message may include an indication which indicates that the CHO evaluation is stopped when the timer for leaving without a response is running.

In some embodiments, the UE information response message may include an indication which indicates that a HO command is not performed. To put this another way, the indication may indicate that a HO command is not performed when the timer for leaving without a response is running.

It should be appreciated by persons skilled in the art that the sequence of the operations in exemplary procedure 700 may be changed and some of the operations in exemplary procedure 700 may be eliminated or modified, without departing from the spirit and scope of the disclosure.

FIG. 8 illustrates a flow chart of exemplary procedure 800 of wireless communications in accordance with some embodiments of the present disclosure. Details described in all of the foregoing embodiments of the present disclosure are applicable for the embodiments shown in FIG. 8.

Referring to FIG. 8, UE 810 may function as UE 110 shown in FIG. 1, and BS 820a and BS 820b may function as BS 120 shown in FIG. 1. UE 810 may access BS 820a. UE 810 may have UL data for voice.

In some embodiments, BS 820a may be associated with a RAT such as NR and BS 820b may be associated with another RAT such as E-UTRA. BS 820a may decide to handover UE 810 to a target cell (e.g., BS 820b) for voice traffic. In operation 811, UE 810 may receive a handover command (e.g., MobilityFromNRCommand as specified in 3GPP specifications) from BS 820a.

In some embodiments, in response to receiving the handover command, UE 810 may stop the timer associated with measurement report triggering (e.g., T312 as specified in 3GPP specifications) in the case that the timer associated with measurement report triggering is running.

In some embodiments, the handover command may include a voice fallback indication. That is, the handover command is for voice fallback.

In some embodiments, the handover command may include a trigger condition(s) to report a successful handover report. In some embodiments, when a trigger condition is met, UE 810 may report the successful handover report. For example, the trigger condition may include one or more of the following:
a threshold for a ratio (e.g., percentage) between the elapsed time of a timer for path switch (e.g., T304 as specified in 3GPP specifications) and the configured value of the timer for path switch;
a threshold for a ratio (e.g., percentage) between the elapsed time of a physical layer problem timer (e.g., T310 as specified in 3GPP specifications) and the configured value of the physical layer problem timer; and
a threshold for a ratio (e.g., percentage) between the elapsed timer of a timer associated with measurement report triggering (e.g., T312 as specified in 3GPP specifications) and the configured value(s) of the timer associated with measurement report triggering.

In operation 813, in response to receiving the handover command, UE 810 may start a timer for path switch (e.g., T304 as specified in 3GPP specifications). In operation 815, UE 810 may access BS 820b (e.g., an E-UTRA cell) according to the handover command. In some embodiments, UE 810 may successfully access BS 820b and may then stop the timer for path switch.

In some embodiments of the present disclosure, during the handover procedure, UE 810 may store information associated with the handover in response to a trigger condition for reporting the successful handover report being met. As will be described later, UE 810 may transmit the stored successful handover report to the network.

In some other embodiments of the present disclosure, UE 810 is not expected to report a successful handover report if the handover is triggered for the purpose of voice fallback. For example, UE 810 may prohibit storing information associated with the handover in response to the trigger condition for reporting the successful handover report being met.

In operation 817, UE 810 may transmit an RRC reconfiguration complete message to BS 820b. The message may indicate that information associated with the successful handover report is available. In some embodiments, the message may indicate which trigger condition(s) has been met.

In some embodiments of the present disclosure, a UE information procedure may be performed to obtain the successful handover report.

For example, in operation 819, in response to the RRC reconfiguration complete message, BS 820b may transmit a UE information request message to UE 810. The UE information request message may request UE 810 to report the successful handover report.

In operation 821, UE 810 may transmit a UE information response message in response to the reception of the UE information request message. The UE information response message may include a successful handover report. The successful handover report may include at least one of the following: a voice fallback indication or information related to the target cell. The information related to the target cell may include, for example, at least one of the following: an indication indicating that a physical layer problem timer (e.g., T310 as specified in 3GPP specifications) is started within a period after the handover; or an indication indicating that a timer associated with measurement report triggering is started (e.g., T312 as specified in 3GPP specifications) within a period after the handover.

The above information could assist the source BS, the target BS or both to optimize the system. For example, by distinguishing a normal handover and a voice fallback handover, the network may not use information associated with a voice fallback handover to optimize the normal handover.

In operation 823, BS 820b may forward the successful handover report to the source BS 820a via, for example, an Xn message. The Xn message may include a failure indication message or another Xn message (e.g., a message specific for the transmission of the successful handover report). In some examples, the successful handover report (or the information response message) from UE 810 may be transmitted to BS 820a as a container. In some examples, the Xn message may include an indication of “successful handover report”.

It should be appreciated by persons skilled in the art that the sequence of the operations in exemplary procedure 800 may be changed and some of the operations in exemplary procedure 800 may be eliminated or modified, without departing from the spirit and scope of the disclosure.

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. In some examples, the procedure may be performed by a UE.

Referring to FIG. 9, in operation 911, a UE may receive a UE information request message. In operation 913, the UE may transmit a UE information response message in response to receiving the UE information request message. In some embodiments, the UE information response message may include at least one of the following: an RLF report associated with a MUSIM operation of the UE; or a successful handover report, wherein the handover may include a handover of the UE from a first RAT to a second RAT for voice fallback.

For example, in some embodiments of the present disclosure, the UE information response message may include an RLF report as described with respect to FIGS. 5-7. For instance, the UE may include a first USIM and a second USIM, and the UE is in a connected state in a first RAN associated with the first USIM.

In some embodiments of the present disclosure, the UE may perform at least one of: prohibit initiating a reestablishment procedure in response to detecting an RLF associated with the first RAN when a timer for leaving without a response is running; prohibit storing RLF information in response to detecting the RLF associated with the first RAN when the timer for leaving without a response is running; store the RLF information in response to detecting the RLF associated with the first RAN when the timer for leaving without a response is not running; or store the RLF information in response to detecting the RLF associated with the first RAN when the timer for leaving without a response is running. In some embodiments, the RLF report associated with the MUSIM operation may include the RLF information or both the RLF information and an indication, wherein the indication indicates that the timer for leaving without a response is running when the RLF is detected.

In some embodiments of the present disclosure, the UE may transmit, to the first RAN, a UE assistant information message to request to leave the connected state in the first RAN; and start a timer for leaving without a response in response to the transmission of the UE assistant information message. In some embodiments, the UE may perform at least one of: prohibit executing a CHO in response to a CHO execution condition being met when the timer for leaving without a response is running; stop evaluating a CHO execution condition when the timer for leaving without a response is running; or prohibit performing a HO command received from the first RAN when the timer for leaving without a response is running.

In some embodiments, the UE may re-enter the connected state in the first RAN. The UE information request message may be received after re-entering the connected state in the first RAN. The RLF report associated with the MUSIM operation may include at least one of the following: a first indication indicating that a CHO is not performed or indicating that a CHO is not performed when the timer for leaving without a response is running; a second indication indicating that the CHO evaluation is stopped when the timer for leaving without a response is running; or a third indication indicating that a HO command is not performed or indicating that a HO command is received when the timer for leaving without a response is running.

For example, in some embodiments of the present disclosure, the UE information response message may include a successful handover report as described with respect to FIG. 8.

In some embodiments of the present disclosure, the UE may receive a command for the handover from the first RAT to the second RAT, wherein the command is for voice fallback. The UE may successfully access a cell associated with the second RAT according to the command.

In some embodiments, the UE may store information associated with the handover from the first RAT to the second RAT in response to a trigger condition for reporting a successful handover report being met. The UE information request message may be received after successfully accessing the cell associated with the second RAT. The successful handover report may include at least one of the following: a voice fallback indication; or information related to the cell associated with the second RAT. In some embodiments, the information related to the cell associated with the second RAT may include at least one of the following: a first indication indicating that a physical layer problem timer is started within a period after the handover from the first RAT to the second RAT; or a second indication indicating that a timer associated with measurement report triggering is started within a period after the handover from the first RAT to the second RAT.

In some embodiments, the UE may prohibit storing information associated with the handover from the first RAT to the second RAT in response to a trigger condition for reporting a successful handover report being met.

It should be appreciated by persons skilled in the art that the sequence of the operations in exemplary procedure 900 may be changed and some of the operations in exemplary procedure 900 may be eliminated or modified, without departing from the spirit and scope of the disclosure.

FIG. 10 illustrates a flow chart of exemplary procedure 1000 for wireless communications in accordance with some embodiments of the present disclosure. Details described in all of the foregoing embodiments of the present disclosure are applicable for the embodiments shown in FIG. 10. In some examples, the procedure may be performed by a BS.

Referring to FIG. 10, in operation 1011, a BS may transmit, to a UE, a UE information request message. In operation 1013, the BS may receive a UE information response message in response to the UE information request message. In some embodiments, the UE information response message may include at least one of the following: an RLF report associated with a MUSIM operation of the UE; or a successful handover report, wherein the handover may include a handover of the UE from a first RAT to a second RAT for voice fallback.

For example, in some embodiments of the present disclosure, the UE information response message may include an RLF report as described with respect to FIGS. 5-7.

In some embodiments, the first BS may be associated with a first RAN. The RLF report associated with the MUSIM operation may include information of an RLF between a second BS associated with the first RAN and the UE, and an indication which indicates that a timer for leaving without a response is running at the UE when the RLF occurs.

In some embodiments, the first BS may be associated with a first RAN. The RLF report associated with the MUSIM operation may include at least one of the following: a first indication indicating that a CHO is not performed at the UE or indicating that a CHO is not performed at the UE when a timer for leaving without a response is running at the UE; a second indication indicating that the CHO evaluation is stopped at the UE when the timer for leaving without a response is running at the UE; or a third indication indicating that a HO command is not performed at the UE or indicating that a HO command is received at the UE when the timer for leaving without a response is running at the UE, wherein the HO command is transmitted from a second BS associated with the first RAN.

For example, in some embodiments of the present disclosure, the UE information response message may include a successful handover report as described with respect to FIG. 8.

In some embodiments, the first BS may be associated with the second RAT. The successful handover report may include at least one of the following: a voice fallback indication; or information related to a serving cell of the UE.

The information related to the serving cell of the UE may include at least one of the following: a first indication indicating that a physical layer problem timer is started within a period after a successful handover of the UE from the first RAT to the serving cell of the UE; or a second indication indicating that a timer associated with measurement report triggering is started within a period after the successful handover of the UE from the first RAT to the serving cell of the UE.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

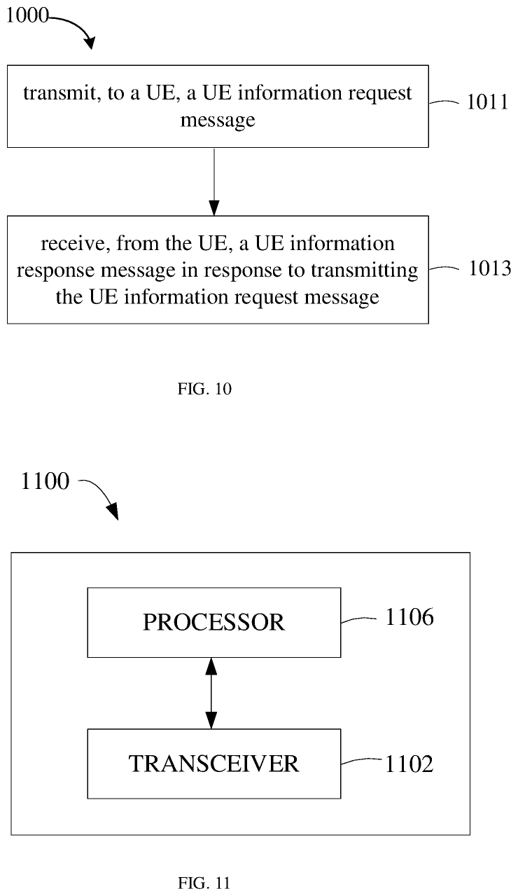

FIG. 11 illustrates a block diagram of exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present application, the transceiver 1102 may be divided into two devices, such as a receiving circuitry and a transmitting circuitry. In some embodiments of the present application, the apparatus 1100 may further include an input device, a memory, and/or other components. In some embodiments of the present application, the apparatus 1100 may be a UE including at least one SIM (e.g., USIM). The at least one SIM may be coupled to the processor 1106.

In some embodiments of the present application, the apparatus 1100 may be a UE. The transceiver 1102 and the processor 1106 may interact with each other so as to perform the operations with respect to the UE described above, for example, in FIGS. 1-10.

In some embodiments of the present application, the apparatus 1100 may be a BS. The transceiver 1102 and the processor 1106 may interact with each other so as to perform the operations with respect to the BS described above, for example, in FIGS. 1-10.

In some embodiments of the present application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present application, the apparatus 1100 may further include at least one non-transitory computer-readable medium. For example, in some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive a UE information request message; and
transmit a UE information response message in response to receiving the UE information request message, wherein the UE information response message comprises at least one of the following:
a radio link failure (RLF) report associated with a multiple universal subscriber identity module (MUSIM) operation of the UE; or
a successful handover report, wherein the handover comprises a handover of the UE from a first radio access technology (RAT) to a second RAT for voice fallback.

2. The UE of claim 1, wherein the UE further comprises a first USIM and a second USIM, and the UE is in a connected state in a first radio access network (RAN) associated with the first USIM; and
wherein the at least one processor is coupled to the first USIM and the second USIM, and is configured to cause the UE to perform at least one of:
prohibit initiating a reestablishment procedure in response to detecting an RLF associated with the first RAN when a timer for leaving without a response is running;
prohibit storing RLF information in response to detecting the RLF associated with the first RAN when the timer for leaving without a response is running;
store the RLF information in response to detecting the RLF associated with the first RAN when the timer for leaving without a response is not running; or
store the RLF information in response to detecting the RLF associated with the first RAN when the timer for leaving without a response is running.

3. The UE of claim 2, wherein the RLF report associated with the MUSIM operation comprises the RLF information or both the RLF information and an indication, wherein the indication indicates that the timer for leaving without a response is running when the RLF is detected.

4. The UE of claim 1, wherein the UE further comprises a first USIM and a second USIM, and the UE is in a connected state in a first radio access network (RAN) associated with the first USIM; and
wherein the at least one processor is coupled to the first USIM and the second USIM, and is configured to cause the UE to:
transmit, to the first RAN, a UE assistant information message to request to leave the connected state in the first RAN; and
start a timer for leaving without a response in response to transmission of the UE assistant information message.

5. The UE of claim 4, wherein the at least one processor is further configured to cause the UE to perform at least one of:
prohibit executing a conditional handover (CHO) in response to a CHO execution condition being met when the timer for leaving without a response is running;
stop evaluating a CHO execution condition when the timer for leaving without a response is running; or
prohibit performing a handover (HO) command received from the first RAN when the timer for leaving without a response is running.

6. The UE of claim 5, wherein the at least one processor is further configured to cause the UE to re-enter the connected state in the first RAN, and the UE information request message is received after re-entering the connected state in the first RAN; and
wherein the RLF report associated with the MUSIM operation comprises at least one of the following:
a first indication indicating that a CHO is not performed or indicating that a CHO is not performed when the timer for leaving without a response is running;
a second indication indicating that CHO evaluation is stopped when the timer for leaving without a response is running; or
a third indication indicating that a HO command is not performed or indicating that a HO command is received when the timer for leaving without a response is running.

7. The UE of claim 1, wherein the at least one processor is configured to cause the UE to:
receive a command for the handover from the first RAT to the second RAT, wherein the command is for voice fallback; and
successfully access a cell associated with the second RAT according to the command.

8. The UE of claim 7, wherein the at least one processor is configured to cause the UE to store information associated with the handover from the first RAT to the second RAT in response to a trigger condition for reporting a successful handover report being met;
wherein the UE information request message is received after successfully accessing the cell associated with the second RAT; and
wherein the successful handover report comprises at least one of the following:
a voice fallback indication; or
information related to the cell associated with the second RAT.

9. The UE of claim 8, wherein the information related to the cell associated with the second RAT comprises at least one of the following:
a first indication indicating that a physical layer problem timer is started within a period after the handover from the first RAT to the second RAT; or
a second indication indicating that a timer associated with measurement report triggering is started within a period after the handover from the first RAT to the second RAT.

10. The UE of claim 7, wherein the at least one processor is configured to cause the UE to prohibit storing information associated with the handover from the first RAT to the second RAT in response to a trigger condition for reporting a successful handover report being met.

11. A first base station (BS), comprising:
at least one memory; and
at least one processor coupled with the at least one memory and configured to cause the first base station to:
transmit, to a user equipment (UE), a UE information request message; and
receive, from the UE, a UE information response message in response to transmitting the UE information request message, wherein the UE information response message comprises at least one of the following:
a radio link failure (RLF) report associated with a multiple universal subscriber identity module (MUSIM) operation of the UE; or
a successful handover report, wherein the handover comprises a handover of the UE from a first radio access technology (RAT) to a second RAT for voice fallback.

12. The first base station of claim 11, wherein the first BS is associated with a first radio access network (RAN), and
wherein the RLF report associated with the MUSIM operation comprises information of an RLF between a second BS associated with the first RAN and the UE, and an indication which indicates that a timer for leaving without a response is running at the UE when the RLF occurs.

13. The first base station of claim 11, wherein the first BS is associated with a first radio access network (RAN), and the RLF report associated with the MUSIM operation comprises at least one of the following:
a first indication indicating that a conditional handover (CHO) is not performed at the UE or indicating that a CHO is not performed at the UE when a timer for leaving without a response is running at the UE;
a second indication indicating that CHO evaluation is stopped at the UE when the timer for leaving without a response is running at the UE; or
a third indication indicating that a handover (HO) command is not performed at the UE or indicating that a HO command is received at the UE when the timer for leaving without a response is running at the UE, wherein the HO command is transmitted from a second BS associated with the first RAN.

14. The first base station of claim 11, wherein the first BS is associated with the second RAT, and the successful handover report comprises at least one of the following:
a voice fallback indication; or
information related to a serving cell of the UE.

15. A method performed by a user equipment (UE), the method comprising:
receiving a UE information request message; and
transmitting a UE information response message in response to receiving the UE information request message, wherein the UE information response message comprises at least one of the following:
a radio link failure (RLF) report associated with a multiple universal subscriber identity module (MUSIM) operation of the UE; or
a successful handover report, wherein the handover comprises a handover of the UE from a first radio access technology (RAT) to a second RAT for voice fallback.

16. The method of claim 15, wherein the UE comprises a first USIM and the UE is in a connected state in a first radio access network (RAN) associated with the first USIM, and wherein the method further comprises:
prohibiting initiating a reestablishment procedure in response to detecting an RLF associated with the first RAN when a timer for leaving without a response is running;
prohibiting storing RLF information in response to detecting the RLF associated with the first RAN when the timer for leaving without a response is running;
storing the RLF information in response to detecting the RLF associated with the first RAN when the timer for leaving without a response is not running; or
storing the RLF information in response to detecting the RLF associated with the first RAN when the timer for leaving without a response is running.

17. The method of claim 16, wherein the RLF report associated with the MUSIM operation comprises the RLF information or both the RLF information and an indication, wherein the indication indicates that the timer for leaving without a response is running when the RLF is detected.

18. The method of claim 15, wherein the UE comprises a first USIM and the UE is in a connected state in a first radio access network (RAN) associated with the first USIM, and wherein the method further comprises:
transmitting, to the first RAN, a UE assistant information message to request to leave the connected state in the first RAN; and
starting a timer for leaving without a response in response to transmission of the UE assistant information message.

19. The method of claim 18, further comprising at least one of:
prohibiting executing a conditional handover (CHO) in response to a CHO execution condition being met when the timer for leaving without a response is running;
stopping evaluating a CHO execution condition when the timer for leaving without a response is running; or
prohibiting performing a handover (HO) command received from the first RAN when the timer for leaving without a response is running.

20. A processor for wireless communication, comprising:
at least one controller coupled with at least one memory and configured to cause the processor to:
receive a user equipment (UE) information request message; and
transmit a UE information response message in response to receiving the UE information request message, wherein the UE information response message comprises at least one of the following:
a radio link failure (RLF) report associated with a multiple universal subscriber identity module (MUSIM) operation of the UE; or
a successful handover report, wherein the handover comprises a handover of the UE from a first radio access technology (RAT) to a second RAT for voice fallback.
